(19) United States
(12) Patent Application Publication
(10) Pub. No.: US 2015/0186847 A1
(43) Pub. Date: Jul. 2, 2015

(54) Intelligent Tool for Matching Candidates to Job Opportunities

(71) Applicants: Krishnadas Menon, Foster City, CA (US); Paige Cherny, Redmond, WA (US); Jayasri Korukonda, San Bruno, CA (US); Sunil Kamadolli, Sunnyvale, CA (US); Balaarjunan Muthiah, Berkeley, CA (US)

(72) Inventors: Krishnadas Menon, Foster City, CA (US); Paige Cherny, Redmond, WA (US); Jayasri Korukonda, San Bruno, CA (US); Sunil Kamadolli, Sunnyvale, CA (US); Balaarjunan Muthiah, Berkeley, CA (US)

(73) Assignee: SUCCESSFACTORS, INC.

(21) Appl. No.: 14/144,259

(22) Filed: Dec. 30, 2013

(51) Int. Cl. G06Q 10/10

(52) U.S. Cl. CPC G06Q 10/1053

(57) ABSTRACT

In one embodiment, an intelligent recruiting feature or service is provided for a camera-enabled mobile device such that a user of such mobile device can use the mobile device to upload candidate data to an Applicant Tracking System (ATS) in a remote location. In another embodiment, the ATS uses candidate data stored in a candidate information repository to match candidates to job requisitions and/or skill needs of a company.

### BACKGROUND

The invention disclosed herein relates generally to computing and data processing. More specifically, the invention relates to a computer based tool for capturing and processing data.

Recruiters for large companies frequently take part in job fairs or career events at universities or other venues to advertise their company and make connections with potential job candidates. At these events, recruiters can encounter and receive job applicant material, such as resumes, from a large number of potential applicants. Each encounter may be of relatively short duration. In addition, there may be a number of different positions within the company for which candidates are being sought.

Processing all the information obtained at such career events to match promising candidates to positions suited to their qualifications can be a challenging and time consuming task. Among other things, all the collected resumes may need to be reviewed to insure that promising candidates are identified. Further, a recruiter may need to review notes concerning interactions with different candidates and associate useful information contained in those notes with corresponding candidates. A system for keeping track of the resumes and other useful information may be need to be manually maintained. In addition, the recruiter may need to review the resumes and notes, with a view to matching candidates with one of a plurality of available job positions and/or skill set needs within the company. In some instances, some of these job positions and skill set needs may be in areas outside of a particular recruiter's area of expertise. Recruiters may also need to initiate follow up communications with promising candidates in order to encourage those candidates to apply for positions with the company.

The above provides just some examples of the information capture, tracking and processing challenges that may arise in the course of a recruiting and hiring process. It would be advantageous to provide improved computer based tools for assisting in a recruiting and hiring process.

### BRIEF SUMMARY

Various embodiments of the present disclosure provide computer based systems and techniques for entering information about skill categories and job requisitions for which a company is seeking candidates. Further embodiments provide systems and techniques for capturing candidate data obtained in the course of recruiting events to match candidates to skill categories and job requisitions for which the company is seeking candidates.

According to some embodiments, a request identifying an event and one or more skill categories is received. Candidate profiles associated with the event and the one or more skill categories are received. A graphical dashboard including information identifying the event, the one or more skill categories and a total number of candidate profiles associated with the one or more skill categories, is generated. The graphical dashboard is provided to a mobile device or Web application.

According to some embodiments, data about a company's hiring needs is stored in a hiring needs data structure, wherein the company's hiring needs are divided into skill categories. Each skill category is associated with a particular group of skills or with a particular department of the company, and job requisitions for specific job openings at a company are associated with one or more of the skill categories.

According to some embodiments, the hiring needs data structure is associated with a particular career event, and is used to hold information regarding hiring needs for which recruiters are seeking job candidates at said career event.

According to some embodiments, a first job requisition stored in the hiring needs data structure is associated with a first candidate about whom candidate information is stored in a candidate information repository.

According to some embodiments, the results of such matching are displayed to a user, and the user is given the option of filtering the results of such matching to present only the job candidates matching the job requisitions who were encountered at a specific career event or during a specific time frame.

According to some embodiments, an intelligent recruiting feature is provided on a mobile device which enables a user to quickly and easily capture candidate data and upload it to a system for tracking applicants. In some embodiments, a camera enabled mobile devices is used to capture images of candidate data (for example, job applicant documents such as resumes) and upload that information to an applicant tracking system (ATS) of a company. Examples of such mobile devices include personal digital assistants (PDAs), smartphones, and tablet computers. Applicant Tracking Systems are used to track candidates applying for jobs in a company.

In some embodiments, the ATS may process the received image(s) and use the information retrieved from the image(s) regarding a candidate's experience and skill sets to create a profile for the candidate which it then stores. A profile may be a description of a candidate, describing his skills, and past roles and responsibilities, for example.

The ATS may also use the information retrieved from the received image(s) to match the candidates to existing personnel needs within a company.

In some embodiments, information resulting from such image processing, information retrieval and matching procedures may be transmitted to the mobile device for displaying to a user. In this way, a user may be provided with an intelligent recruiting tool that enables her to easily capture candidate data and then receive the results of an automated process for storing and analyzing the received data. Such a tool may be used to assist the recruiter to quickly match job candidates to appropriate job positions and/or skill needs within a company.

In some embodiments, further automated features may be provided for initiating, or assisting in initiating, communications with a candidate once a profile for the candidate has been created within a company's ATS.

The above summary provides an overview of some aspects of the present disclosure. The following detailed description and accompanying drawings provide a better understanding of the nature and advantages of the present invention.

### BRIEF DESCRIPTION OF THE DRAWINGS

The invention is illustrated in the figures of the accompanying drawings which are meant to be exemplary and not limiting, in which like references refer to like or corresponding parts, and in which:

FIG. 1 illustrates a block diagram presenting a network topology in which captured images obtained by a mobile device are transmitted to and processed by a remote applicant tracking system (ATS) engine according to one embodiment of the present invention;

FIG. 2 is a flow diagram presenting a method of capturing and processing candidate data using images captured by a mobile device according to one embodiment of the present invention;

FIGS. 3A-3C are diagrammatic representations of screens which may be displayed on a mobile device in the course of capturing candidate data according to one embodiment of the present invention;

FIG. 4 is a flow diagram presenting a method of processing candidate data and matching candidates to open job positions according to one embodiment of the present invention;

FIGS. 5A-5C are diagrammatic representations showing the relationship between event objects, category objects and job requisition objects according to one embodiment of the present invention;

FIGS. 6A-6C are diagrammatic representations of stages in a process for matching candidates to appropriate job requisitions according to one embodiment of the present invention;

FIG. 7 illustrates hardware of a special purpose computing machine configured to perform a process according to various embodiments of the present invention.

### DETAILED DESCRIPTION

Described herein are improved systems and techniques for capturing and making use of candidate data obtained in the course of a recruiting and/or hiring process. In the following description, for purposes of explanation, numerous examples and specific details are set forth in order to provide a thorough understanding of various embodiments of the present disclosure. It will be evident, however, to one skilled in the art that various embodiments of the present disclosure as defined by the claims may include some or all of the features in these examples alone or in combination with other features described below, and may further include modifications and equivalents of the features and concepts described herein.

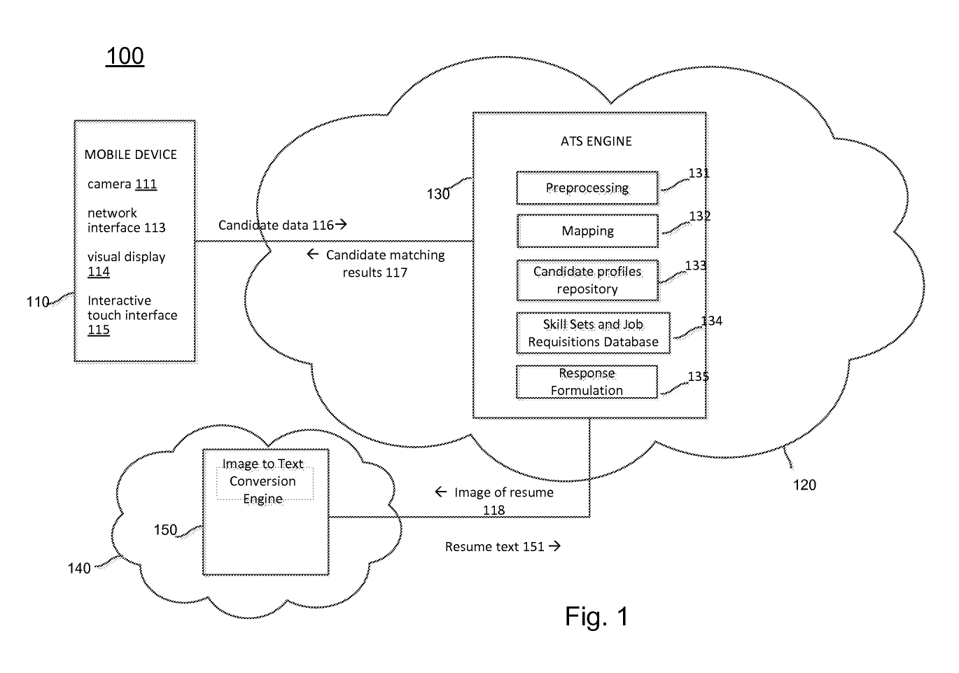

Embodiments of a method and system for capturing and making use of candidate data obtained in the course of a recruiting and/or hiring process, in accordance with various embodiments of the present disclosure, are described herein with reference to the drawings in FIGS. 1 through 7.

Recruiters face the challenge of needing to absorb and process large amounts of information regarding candidates, as well as skill set needs and open job positions of a company, in order to match candidates to appropriate existing needs within a company.

As noted above, recruiters may participate in job fairs or career events where they encounter, and receive resumes from, a large number of potential applicants. Processing all the information obtained about candidates at such career events and/or through other means can be a challenging and time consuming task. Requiring a recruiter to perform the task alone not only places a significant burden upon her, but is also likely to result in the loss of some useful information.

As described further below, various embodiments provide systems and methods for efficiently capturing detailed data from a candidate-recruiter interaction, and processing and using that information in a manner that enhances the overall recruitment experience for candidates and recruiters.

As described above, various embodiments of the present disclosure provide a system or method for capturing and processing information obtained in the course of a recruiting and hiring process. It will be understood, however, that the invention is not restricted to this context but may be utilized in any context where capturing and processing data regarding a plurality of different entities (e.g., objects or persons) to match them to corresponding needs or requirements would be useful.

Embodiments for an intelligent recruiting tool using mobile devices may be implemented in a wide variety of networking contexts. Turning to FIG. 1, a network topology comprising hardware and software components configured according to one embodiment of the present invention is illustrated. The network topology presented comprises a mobile device 110, connected to a first network 120 that includes an Applicant Tracking System (ATS) engine 130 that is part of an Applicant Tracking System.

ATS engine 130 may comprises one or more servers, and may include any suitable modules for associating a candidate with open job positions and talent needs of an organization based on image capture data as discussed further herein. ATS engine 130 shown in FIG. 1 includes an information processing module 131, a matching engine 132, skill sets and job requisitions database 133 (which stores information about available job positions and skill set needs within the company), a candidate profiles repository 134, and a response formulating module 135, which operate together to process candidate data, associate candidates with open job positions and/or skill set needs, and return hiring information to mobile device 110 for displaying to a user.

ATS engine 130 may be accessed by mobile device 110 through a wireless connection to the Internet, for example. Embodiments of the above network topology may be implemented in a wide variety of network environments including, for example, Ethernet networks, TCP/IP-based networks, telecommunications networks, and wireless networks, etc., or a combination of such networks

ATS engine 130 is connected to a second network 140, which includes an Image to Text Conversion engine 150. Second network 140 may be a private network associated with a particular company, for example, or it may be a public network. Image to Text Conversion engine 150 may perform image to text conversion using any one of the techniques for performing such conversion available in the art.

As noted above, ATS engine 130 includes a preprocessing module 131, a matching engine 132, skill sets and job requisitions database 133 (which stores information about open positions and skill set needs within the company), a candidate profiles repository 134, and a response formulating module 135, which operate together to process candidate data and return hiring information to mobile device 110 for display to a user.

According to one embodiment, when ATS engine 130 receives candidate data 116 from mobile device 110, its preprocessing module 131 processes that data to retrieve information which can be used to create a candidate profile for the candidate. Once created, the candidate profile is saved in candidate profiles repository 134.

In a separate step, information relating to skill set needs and open job positions within a company are saved in skill sets and job requisitions database 133.

Matching engine 132 of ATS engine 130 uses data from both skill sets and job requisitions database 133 and candidate profiles repository 134 to match candidates to appropriate skill set needs and open job positions within the company.

In some embodiments, the data obtained from candidate profiles repository 134 for use in such a matching process may be limited to data concerning candidates who were encountered at a particular job fair or career event. Limiting the data in this way may allow a recruiter to quickly assess the productive leads obtained in a particular job fair or career event. In alternative embodiments, the data obtained from candidate profiles repository 134 for use in such a matching process may include data concerning any candidates with presently pending applications at the company.

In some embodiments, the data obtained from skill sets and job requisitions database 133 for use in the above described matching process may be limited to data regarding a particular category of skill sets or jobs. For example, the data may be restricted to skill sets or job requisitions relating to computer programming Allowing the skill sets and job requisitions data to be restricted in this way gives recruiters the ability to perform more focused analyses regarding particular areas of hiring need. In alternative embodiments, the data obtained from skill sets and job requisitions database 133 for use in such a matching process may include data regarding any skill set needs or job requisitions entered into the database.

After appropriate data has been obtained from both talent and job requisitions database 132 and candidate profiles repository 133, as noted above, matching engine 132 uses that information to map candidates to skill set needs or open job positions for which they are qualified. For example, a job requisition may require a minimum of ten years of experience, as well as skill in programming in Java, and in that case, matching engine 132 would find all candidates whose profiles are provided in the data retrieved from candidate profiles repository who meet those criteria.

Response formulating module 135 then formulates a message to return to the user regarding a group of candidates and the job requisitions, or skill set groups, they match with, for example. Response formulating module 135 may identify, for example, for each retrieved job requisition, an associated group of qualified candidates. The response message can be in the form of text to be shown on a user interface of mobile device 110, or text to be displayed on a user interface associated with a Web application, for example. In one example, a recruiter may access information formulated by response formulating module 135 on a user dashboard displayed in a Web Applications associated with the Applicant Tracking System (ATS) itself.

Various other forms of response messages will be apparent to one of skill in the art. For example, in other embodiments, candidate matching information 117 returned by ATS engine 130 to mobile device 110 may be communicated to a user using a natural language voice interface of mobile device 110.

Response formulating module 134 then transmits candidate matching information 117, whatever form it takes, back to mobile device 110.

Implementations are contemplated in which users can interact with ATS engine 130 using a diverse range of mobile devices 110, e.g., a personal digital assistant (PDA), smartphone, a tablet computer, a laptop, etc. As shown in FIG. 1, mobile device 110 is operable to capture and send an image, and text data, to ATS engine 130. As shown, mobile device 110 has a cameras component 111 for capturing images. Mobile device 110 also contains interfaces 113 for communicating with other devices through networked connections. It also has visual and/or audio interfaces for providing information to a user. As illustrated in FIG. 1, mobile device 110 has a visual display 114. The visual display may convey information in the form of text, images, links, etc. Mobile device 110 also has an interactive touch interface 115 for receiving user input, such as text.

In some embodiments, in conjunction with performing intelligent recruiting tool functionality, mobile device 110 further implements application software for matching candidates to relevant job positions as provided by embodiments of the present disclosure. The use of the application software allows mobile device 110 to perform intelligent recruiting functions when used in conjunction with ATS engine 130. Embodiments of relevant ATS server software may be integrated as a component of one or more server applications or it may be a stand-alone program executing on ATS engine 130.

According to one embodiment, ATS engine 130 may comprise a single server. In alternative embodiments, ATS engine 130 may correspond to multiple distributed servers and data stores, which, for example, may be part of a cloud network, and which together perform the functions described herein. Such a system of distributed servers and data stores may execute software programs that are provided as software services (e.g., Software-as-a-Service (SAAS)). Embodiments of a distributed inventory assessment engine 130 may be implemented in a wide variety of network environments as further described herein.

According to one embodiment, ATS engine 130 may match candidates to relevant job openings and skill set needs of a company, based in part on resume text 151 received from image-to-text conversion engine 150 in response to a request from ATS engine 110 to convert resume images captured by mobile device 110. As noted above, image-to-text conversion engine 150 is located in second network 140, which for example may be a private network operated by a particular enterprise.

According to one embodiment, after receiving candidate matching information 117 from ATS engine 130, mobile device 110 may display options for a user to review the matching information 117 in display 114 of mobile device 110.

In one example, a recruiter meets with a candidate in person either at a job fair or career event, and has a conversation with the candidate. The candidate gives a physical copy of his resume to the recruiter. The recruiter captures an image of the candidate's resume, and enters notes of the recruiter's impressions of the candidate, in her mobile device. Any mobile device with camera functionality and networking capability may be used. Capturing an image of the resume may be performed using camera functionality of the mobile device. The notes may be entered using an interactive graphical user interface of the mobile device, for example. In other embodiments, the notes may be entered on a user interface associated with a Web application, for example. In one example, a recruiter may provide regarding a job candidate on a user interfaces of a Web Applications associated with the Applicant Tracking System (ATS).

Information about the candidate including the captured image of his resume, the notes regarding the recruiter's interactions with the candidate, as well as the name of the career event or job fair at which the recruiter encountered the candidate, may be sent to a remote applicant tracking system (ATS) of a company. This information may be sent using an intelligent recruiting tool application running on the recruiter's mobile device.

The ATS may proceed to process the received candidate data to identify the skill sets and other qualifications of the candidate. The ATS may process candidate data in this way for each candidate for whom it receives candidate data. The ATS may then transmit information to the mobile device identifying which candidates have qualifications that meet the requirements of particular job requisitions or skill set needs at the company. Mobile device 110 may then provide this information to the recruiter via a visual display of mobile device 110.

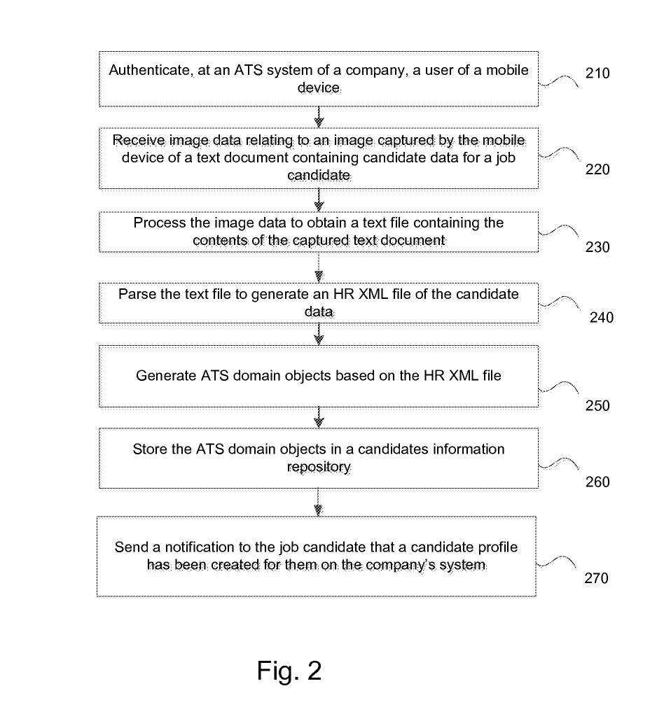

FIG. 2 is a flow diagram illustrating a method performed by an ATS engine according to one embodiment. The specific example of an ATS engine depicted in FIG. 1 will be referenced for purposes of explanation, but it will be understood that, in practice, ATS engines performing the below process need not have all of the features, or the same network context, as ATS engine 130.

According to one embodiment, to initiate intelligent recruiting tool functionality, a user registers mobile device 110 with the Applicant Tracking System (ATS) of their company. Once registration is completed, the user may access the intelligent recruiting feature on their mobile device 110. FIG. 2 illustrates some of the steps that may follow.

In 210, in some embodiments, in order to access the intelligent recruiting tool feature on mobile device 110, a user may need to authenticate herself to ATS engine 130 by, for example, entering a passcode into mobile device 110.

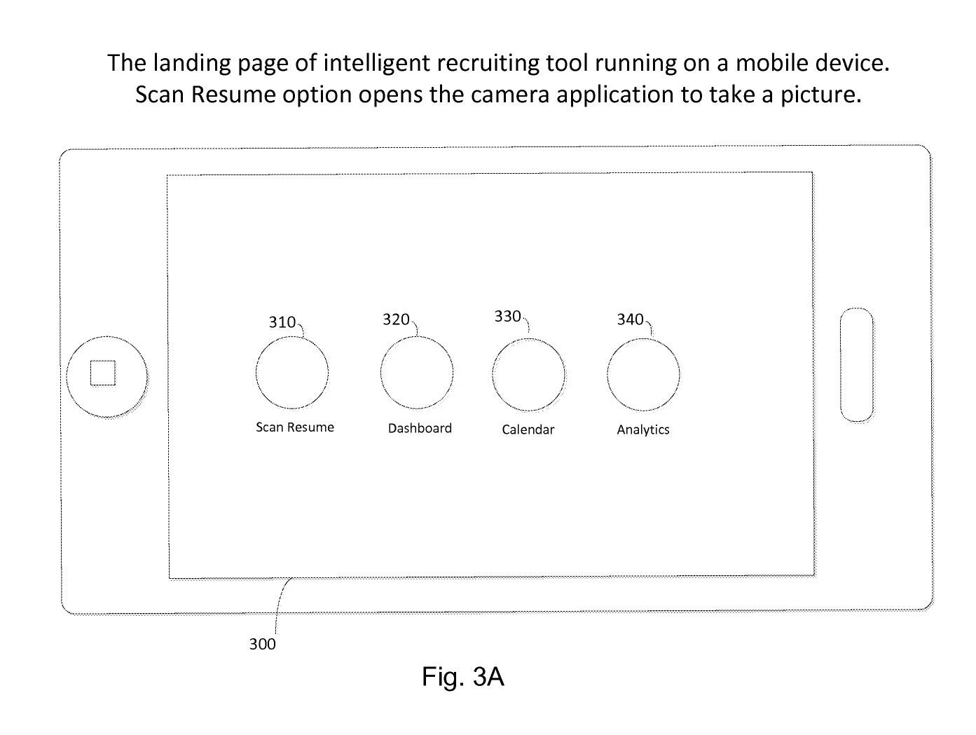

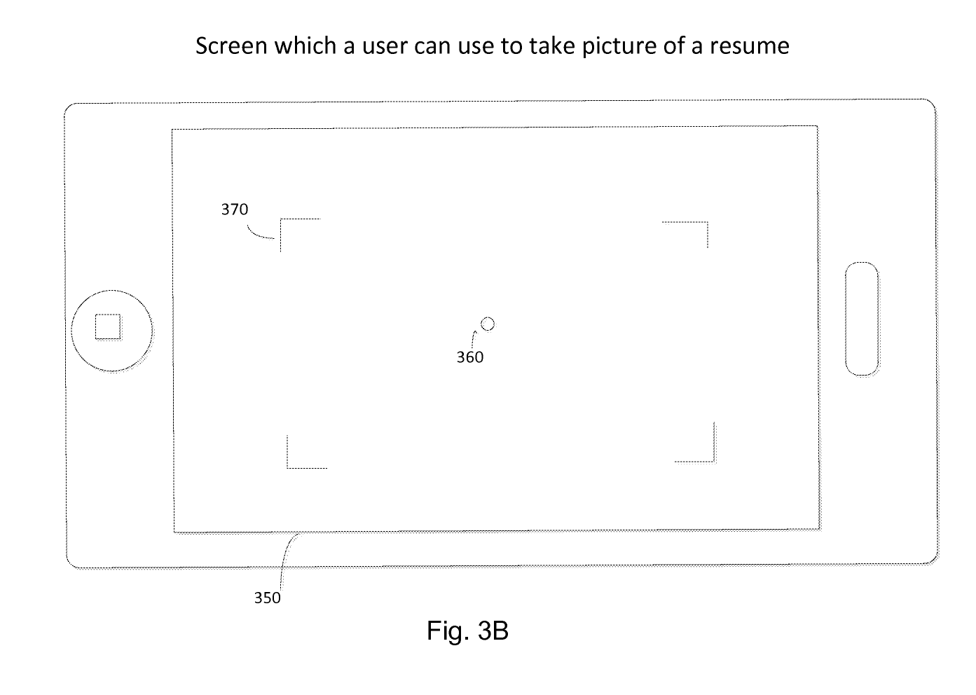

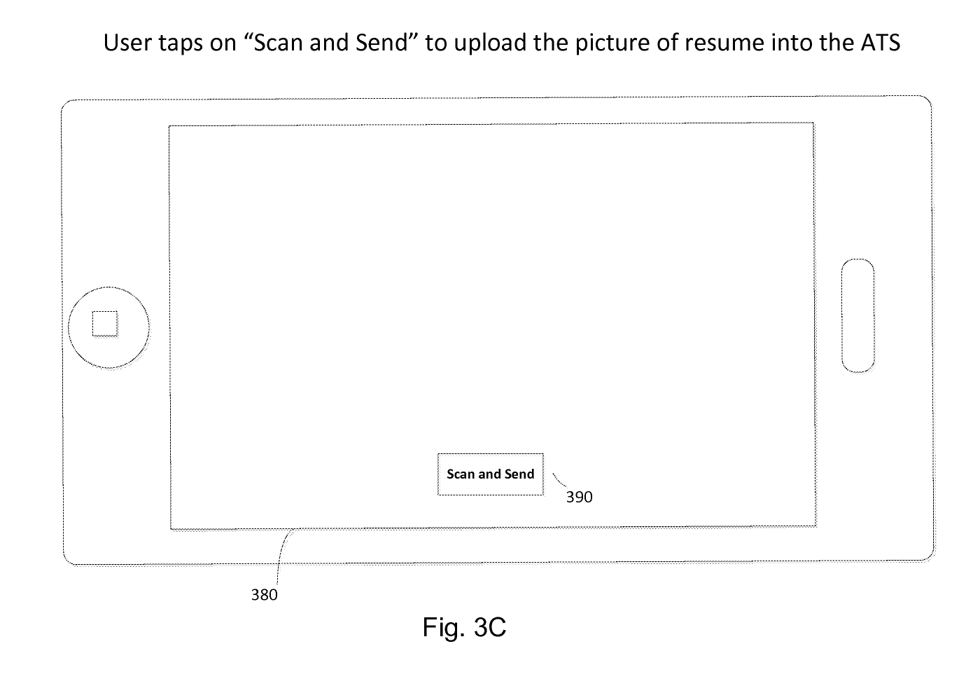

After access has been granted, a screen may be displayed on mobile device 110 enabling the user to choose from among several options. FIG. 3A provides an illustration of an example initial screen 300 that may be displayed to a user when she first accesses the intelligent recruiting feature. Screen 300 may provide options such as “Scan Resume” 310, “Dashboard” 320, “Calendar”330, and/or “Analytics”340.

Once a user selects an option for uploading candidate data to the ATS system (such as the “Scan Resume” option 310), an indication that the candidate data uploading feature has been selected by the user may be received by ATS engine 130, and a new screen 350 may be displayed on mobile device 110. In one example, mobile device 110 may be configured such that when the “Scan Resume” option is selected, mobile device 110 switches to a camera mode and its display shows the user's surroundings as seen through mobile device 110's camera 111's viewfinder.

FIG. 3B provides an illustration of an example screen 350 that may be displayed to a user on mobile device 110 after she selects scan resume option 310. As shown in FIG. 3B, overlaid on the image of the user's surroundings displayed in the viewfinder of mobile device 110's camera, the screen may show aids for taking a picture such as a circle 360 indicating the center of the picture, and lines 370 indicating a rectangular field of view frame which corresponds to a central portion of the prospective picture.

After the user takes a picture of candidate data, for example, a resume, using mobile device 100, a new screen 380, as illustrated in FIG. 3C, may be displayed on mobile device 110 showing the captured image of the resume along with a “scan and send” option 390.

Note that the captured image of the resume is not shown in FIG. 3C, but in practice, it would be shown in the display behind the scan and send option 390. In some embodiments, selecting the scan and send option 390 will result in the captured image being automatically transmitted to remote ATS engine 130. Accordingly, using the intelligent recruiting tool, a user is able to quickly and easily upload an image of a candidate's resume to ATS engine 130 by using the camera and networking functionality of mobile device 110.

In some embodiments, as noted above, a user may also be able to use mobile device 110 to upload comments about the user's interaction with a candidate. These conversation specific comments may later be used in connection with ranking candidates and/or in connection with matching candidates to skill set needs, for example.

Referring back to FIG. 2, in 220, ATS engine 130 (e.g., an application server in company network 120) may receive the image of a candidate's resume sent by mobile device 110. As described above, the image of the candidate's resume may be captured by mobile device 110, and sent to ATS engine 130, using the intelligent recruiting feature running on mobile device 110. In some embodiments, ATS engine 130 may be located in company network 120. In some embodiments, company network 120 may be configured as a cloud network.

In some embodiments, ATS engine 130 may also receive additional information about the candidate in the form of text data that describes a recruiter's interactions with, and/or impressions of, the candidate. The recruiter may input this information into an ATS system by using an interactive graphical user interface of mobile device 110. In other embodiments, a recruiter may input this information to an ATS system by using a user interface of Web application associated with the ATS system.

In alternative embodiments, handwritten notes containing a record of the recruiter's impressions of a candidate may be captured using the camera functionality of mobile device 110 and transmitted to ATS engine 130 in the same manner as described above in connection with the description of capturing and sending an image of the candidate's resume.

Further, in some embodiments, the ATS engine may also receive event information that describes, for example, an event, a location, day, and time, where the recruiter encountered the candidate. Further description regarding such event information is provided below in connection with the discussion of step 260

In 230, after receiving a captured image of a candidate's resume as well as, in some embodiments, text data regarding a recruiter's impressions of the candidate, ATS engine 130 may perform a process to retrieve resume text from the received resume image. In some embodiments, ATS engine 130 may perform this conversion itself. In other embodiments, it may send the captured image of the resume to image-to-text conversion engine 150 to perform the conversion of the resume image to resume text.

In 240, the resume text obtained as a result of step 230 may be parsed to generate a structured language file, for example, an HR XML file. Structured languages, such as XML, are frequently used to identify characteristics of a set of data. Such representations are useful because they can be easily parsed/processed by a computing device to obtain key characteristics information, or to compare characteristics of one set of data (e.g., embodied in one XML file) to another set of data (e.g., embodied in a second XML file).

HR-XML (Human Resources Extensible Markup Language) is an industry standard language that enables companies to simplify the software development process and integrate data about a candidate easily with other systems. HR-XML standards cover a wide range of HR processes and specifications.

An HR XML file may be created that contains data embodying characteristics of a candidate profile. In some embodiments, ATS engine 130 may perform this parsing and generating of a structured language file containing key characteristics of a candidate's profile itself. In other embodiments, it may send the resume text to an outside service that specializes in parsing text files to generate structured language files, to perform the conversion of the resume text to an HR XML file.

To illustrate, below is an example of HR XML code corresponding to a sample candidate profile:

<?xml version=“1.0” encoding=“UTF-8”?>
<Resume xmlns=“http://ns.hr-xml.org/2007-04-15”
xmlns:xsi=“http://www.w3.org/2001/XMLSchema-instance”
xsi:schemaLocation=“http://ns.hr-xml.org/2007-04-15 Resume.xsd”>

<ResumeId>

<IdValue></IdValue>

</ResumeId>
<StructuredXMLResume>

<ContactInfo>

<!-- Name IDs not supported. -->

<PersonName>

<GivenName></GivenName>
<FamilyName></FamilyName>

</PersonName>
<ContactMethod>

<!-- Phone location not supported. -->

<Telephone>

<FormattedNumber></FormattedNumber>

</Telephone>
<Mobile>

<FormattedNumber></FormattedNumber>

</Mobile>
<InternetEmailAddress></InternetEmailAddress>

<!-- Instant message not supported. -->

<PostalAddress>

<!-- Country not found; assumed to be US. -->

<CountryCode>US</CountryCode>
<DeliveryAddress>

<AddressLine></AddressLine>
<AddressLine>Cuidad de la Habana, CP 11900</AddressLine>
<AddressLine>CUBA</AddressLine>

</DeliveryAddress>

</PostalAddress>

</ContactMethod>

</ContactInfo>

<!-- Objective targets not supported. -->

<Objective>To achieve my Master Chef certification and become

executive chef at a fine restaurant.</Objective>

<EmploymentHistory>

<EmployerOrg>

<EmployerOrgName>ABC Co.</EmployerOrgName>
<EmployerContactInfo/>
<PositionHistory>

<Title>Electrician's Assistant</Title>

<!-- HR-XML OrgName required but not supported (no equivalent for it in XML
Resume). -->

<OrgName>

<OrganizationName/>

</OrgName>
<Description>

<!-- Project titles not supported. -->Rewired the city of
Deluth</Description>

<StartDate>

<YearMonth>1993-05</YearMonth>

</StartDate>

</PositionHistory>

</EmployerOrg>
<EmployerOrg>

<EmployerOrgName>SysOps4Cheap.com</EmployerOrgName>
<EmployerContactInfo/>
<PositionHistory>

<Title>Senior System Administrator</Title>

<!-- HR-XML OrgName required but not supported (no equivalent for it in XML
Resume). -->

<OrgName>

<OrganizationName/>

</OrgName>
<Description>Sys.com was a small startup whose aim was to

supply sysadmins over the web. Ran a beowulf cluster of Commodore 64s
<!-- Project titles not supported. -->Used tanks to keep sysadmins fresh in
the mail</Description>

<StartDate>

<Year>1987</Year>

</StartDate>

</PositionHistory>

</EmployerOrg>
<EmployerOrg>

<EmployerOrgName>ABC Hotel</EmployerOrgName>
<EmployerContactInfo/>
<PositionHistory>

<Title>Sous Chef</Title>

<!-- HR-XML OrgName required but not supported (no equivalent for it in XML
Resume). -->

<OrgName>

<OrganizationName/>

</OrgName>
<Description>

<!-- Project titles not supported. -->Created an extensive menu for our
fall offerings
Revamping of Dining Area
Developed 10 new menu items
Prepared daily operations plan
Streamlined procedures for fresh foods procurement</Description>

<StartDate>

<YearMonth>1997-03</YearMonth>

</StartDate>

</PositionHistory>

</EmployerOrg>
<EmployerOrg>

<EmployerOrgName>Zolo</EmployerOrgName>
<EmployerContactInfo/>
<PositionHistory>

<Title>Assistant Chef</Title>

<!-- HR-XML OrgName required but not supported (no equivalent for it in XML
Resume). -->

<OrgName>

<OrganizationName/>

</OrgName>
<Description>Prepared standard daily mise en place, stocks,

and sauces. Assembled cold plates and salads.</Description>

<StartDate>

<YearMonth>1993-04</YearMonth>

</StartDate>
<EndDate>

<YearMonth>1997-01</YearMonth>

</EndDate>

</PositionHistory>

</EmployerOrg>

</EmploymentHistory>
<EducationHistory>

<!-- All degrees assumed to be university-level. -->

<SchoolOrInstitution schoolType=“university”>

<School>

<SchoolName>Culinary Institute of America</SchoolName>

</School>
<Degree>

<DegreeName>AA</DegreeName>
<DegreeMajor>

<Name>Culinary Arts</Name>

</DegreeMajor>
<DatesOfAttendance>

<StartDate>

<YearMonth>1995-05</YearMonth>

</StartDate>

</DatesOfAttendance>
<Comments>Stocks, broths, and soups: A

Sauces: A
Mexican cuisine: B
Spanish cuisine: A
Kitchen sanitation: A
Dessert: B
Culinary history: A
Hotel restaurant management: C</Comments>

</Degree>

</SchoolOrInstitution>

</EducationHistory>
<PublicationHistory>

<Article>

<Title>Preparation of sauces</Title>

<!-- Author IDs not supported. -->

<Name role=“author”>

<FormattedName>John Doe</FormattedName>

</Name>
<Name role=“author”>

<FormattedName>Jenny Doe</FormattedName>

</Name>
<PublicationDate>

<YearMonth>2000-02</YearMonth>

</PublicationDate>
<JournalOrSerialName>Journal of the Culinary

World</JournalOrSerialName>

<PageNumber>132-136</PageNumber>

<!-- Publisher of articles not supported. -->

</Article>

<!-- This publication lacks an article name, so it is assumed to be a book.
Note that this may cause this HR-XML file to be invalid: All articles must
come before books; they cannot be interspersed with each other. In other
words, you might need to reorder your PublicationHistory elements manually
before this file will validate. -->

<Book>

<Title>The Cooking Book</Title>

<!-- Author IDs not supported. -->

<PublicationDate>

<Year>1998</Year>

</PublicationDate>
<PublisherName>Cooking Press,

http://www.deltoid.co/</PublisherName>

</Book>

</PublicationHistory>
<Qualifications>

<!-- Skill area targets not supported. -->
<!-- Skill area title not supported (unless no skill set title is given). -
->

<Competency name=“General Experience”>

<Competency name=“Gastronomy”/>

<!-- Skill level not supported. -->

<Competency name=“Culinary math”/>
<Competency name=“Nutrition”/>
<Competency name=“Sanitation”/>
<Competency name=“Culinary French”/>

<!-- Skill level not supported. -->

<Competency name=“Meat identification”/>
<Competency name=“Wines”/>
<Competency name=“Restaurant Law”/>
<Competency name=“ Sanitation science background”/>

</Competency>
<Competency name=“Culinary Skills”>

<Competency name=“Braise”/>
<Competency name=“Sauté”/>
<Competency name=“Fry”/>
<Competency name=“Bake”/>
<Competency name=“Stocks”/>
<Competency name=“Reductions”/>
<Competency name=“Sauces”/>

</Competency>
<Competency name=“Cuisines”>

<Competency name=“Seafood”/>
<Competency name=“American Regional”/>
<Competency name=“Asian”/>
<Competency name=“Charcuterie”/>
<Competency name=“Garde Manger”/>
<Competency name=“Pâtisserie”/>
<Competency name=“Modern French”/>

</Competency>

<!-- Skill area targets not supported. -->
<!-- Skill area title not supported (unless no skill set title is given). -
->

<Competency name=“Computer Skills”>

<Competency name=“Perl”/>
<Competency name=“J2EE”/>
<Competency name=“XML Parsing”/>
<Competency name=“Debugging”/>

</Competency>

<!-- Skill area targets not supported. -->
<!-- Skill area title not supported (unless no skill set title is given). -
->

<Competency name=“Construction Skills”>

<Competency name=“Hammering”/>
<Competency name=“Drilling”/>
<Competency name=“Sawing”/>
<Competency name=“Wiring”/>
<Competency name=“Plunging”/>

</Competency>

</Qualifications>

<!-- Awards title not supported. -->

<Achievements>

<!-- Award targets not supported. -->

<Achievement>

<Date>

<StringDate>January 1982 - 1985</StringDate>

</Date>
<Description> Honor Roll</Description>
<IssuingAuthority>Culinary Institute of

America</IssuingAuthority>

</Achievement>

<!-- Award targets not supported. -->

<Achievement>

<Date>

<YearMonth>1997-05</YearMonth>

</Date>
<Description>Deluth Award for Best Cook</Description>
<IssuingAuthority>Usenix</IssuingAuthority>

</Achievement>

</Achievements>

<!-- All memberships are assumed to be professional societies. Memberships
title is ignored. -->

<Associations>

<Association>

<Name>Association of Aluminum Utensils</Name>

</Association>
<Association>

<Name>Stonecutters</Name>
<StartDate>

<Year>1934</Year>

</StartDate>
<Role>

<Name>Grand Poobah</Name>

</Role>

</Association>
<Association>

<Name>Society for Creative Cuisine</Name>
<StartDate>

<YearMonth>1993-02</YearMonth>

</StartDate>
<Role>

<Name>Senior Fellow</Name>

</Role>
<Comments>As senior fellow, I was responsible for all

recruiting efforts of the organization.</Comments>

</Association>

</Associations>

<!-- Interests title not supported. -->

<ResumeAdditionalItems>

<ResumeAdditionalItem type=“Hobbies”>

<Description>Kite Flying: Two-time Canadian national

champion.</Description>

</ResumeAdditionalItem>
<ResumeAdditionalItem type=“Hobbies”>

<Description>High-speed driving</Description>

</ResumeAdditionalItem>
<ResumeAdditionalItem type=“Hobbies”>

<Description>Woodworking</Description>

</ResumeAdditionalItem>

</ResumeAdditionalItems>

<!-- Misc not supported. -->
<!-- Referees not supported. -->
<!-- Clearances not supported. -->
<!-- Revision day of month hard-coded to 01. -->

<RevisionDate>2002-05-01</RevisionDate>

</StructuredXMLResume>

</Resume>

In 250, the structured data file obtained in 240 may be converted to ATS specific Candidate profile objects. For example, an HR XML file may be converted into one or more ATS domain objects, such as a Candidate Profile object.

In 260, the created ATS domain object(s) may be saved into candidate profiles repository 134, which is used to store information about candidates. In some embodiments, the candidate profile for a job applicant may include information extracted from the image sent by the mobile device of the applicant's resume. For example, the profile for a candidate may include the candidate's name, contact information, professional skills, professional work history, education history, and interests. The ATS domain object(s) may be used to create a candidate profile for the candidate using preexisting ATS system functionality.

In some embodiments, event information associated with a candidate may also be identified. The event information may describe one or more of an event, a location, day, and time. For example, the event information may identify a job fair that occurred at a particular college campus on May 24, 2013 in San Francisco. In some embodiments, the event information may be received with the candidate's resume. In some embodiments, the mobile application may enable a recruiter to send the event information to the ATS system before or after uploading images of candidate resumes.

In some embodiments, the event information may be retrieved from a recruiter's notes that accompany the candidate's resume. In alternative embodiments, the event information may be determined from a recruiter's profile or calendar. For example, the ATS system may analyze a recruiter's calendar and identify an event the recruiter was at when the image was received and associate the event information with the image of the candidate's resume and/or a profile generated for the candidate.

In some embodiments, a notification inviting a job applicant to apply for a position may be generated. The notification may include, among other things, the candidate's name, an indication that a preliminary candidate profile has been created for the candidate, a link to a job posting on the company's career website where the candidate can apply for a job, event information identifying the event at which the candidate submitted their resume, or any combination thereof. In some embodiments, the notification may include information identifying the recruiter who sent the image of the candidate's resume and contact information for the recruiter. In this way, the candidate may be given a convenient way to follow up with the recruiter whom they met at an event. In some embodiments, the notification may include portions of one or more job postings that may be a match for the candidate's skill set and professional background, thus alerting the candidate to opportunities that may fit with their particular skill set and background.

In 270, a notification may be sent informing the candidate that an application process for the candidate has been initiated by the company. Such notification may take the form of the notification described above in step 260. In some embodiments, the notification may be sent in real-time (i.e., close to the time that the candidate encounters a company's recruiter), and, as noted above, it may inform the candidate that a preliminary candidate profile for the candidate has been created on the company's career site. It may also provide the candidate with information needed to access her created profile (e.g., a username and password).

In some embodiments, such a preliminary candidate profile may include information taken from the candidate's resume, such information automatically loaded into a company's career site from the ATS system. The automatic creation of a preliminary candidate profile by the ATS system may encourage more candidates to apply for positions with the company, as it may substantially reduce the time and effort a candidate needs to expend on creating a candidate profile on the company's career site. For example, a candidate may only need to make revisions to the automatically created candidate profile generated by a company's ATS system, a much easier process than having to generate a candidate profile from scratch.

In some embodiments, a notification may also be sent to the recruiter at this or an earlier stage notifying the recruiter that the preliminary candidate profile has been created and uploaded to the company's career site. Such notification may include similar information as that provided to the candidate in the notification message to the candidate.

Such notification to the recruiter may also, among other things, confirm that the candidate has been sent a notification message, and may include the candidate's contact information so that the recruiter may more easily send a follow up communication to the candidate if the recruiter desires.

Further, in some embodiments, the notification may also alert the recruiter to any problems in deriving a category of information from the candidate resume and/or notes received at the ATS system, enabling the recruiter to add any additional information which the recruiter has at her disposal at this time.

In some embodiments, a request from the candidate to access his profile on the company's career site may be received using the login name and password sent in step 270, and information regarding the candidate's profile may be sent by ATS engine 130 to the candidate's computer.

Numerous benefits are achieved by the above described process. As noted above, the candidate is not required to create a profile on the company's career site. Information retrieved from his resume is automatically retrieved and used to create a candidate profile, which the candidate then only needs to confirm and possibly augment, if desired. The candidate does not have to go through the mundane and time consuming task of creating a candidate profile from scratch on the company's career site. Additionally, the candidate is not required to keep track of recruiter or company information after meeting the recruiter. In some embodiments, an email or other notification is automatically sent to the candidate upon ATS engine 150 creating a candidate profile for the candidate. This automatically generated notification provide a useful basis for further communications between the candidate and the recruiter. Further, as the candidate receives such notification in real time (most likely only a short time after the candidate data is scanned and uploaded to the ATS), the above described solution may significantly improve the candidate application experience, and may even permit the candidate to have another interaction with the recruiter during the same career event, the second conversation now having the advantage of being informed by information provided by ATS engine 150.

Among the advantages obtained by the above process, from the recruiters' perspective, is that a recruiter is not required to carry back and process stacks of resumes, and the recruiter is not required to manually record and process their candidate interaction notes. Further, a recruiter is not required to manually track each candidate and remember to follow-up with them. Further, while at the career event or job fair, the recruiter is given more flexibility to move around the event, since with an intelligent recruiting features on their tablets or other mobile device, recruiters are freed from the need to carry stacks of resumes, and and/take written notes on their interactions with candidates. This mobility frees a recruiter from having to be located at a kiosk, maximizing the recruiter's ability to meet more candidates at the career event.

As described above, various embodiments of the present disclosure provide improved systems and techniques for capturing candidate data and using that data to create candidate profiles in an applicant tracking system. In addition, as further described below, various embodiments of the present disclosure also provide systems and techniques for processing captured candidate data to more efficiently match candidates with skill set needs and/or open job positions at a company.

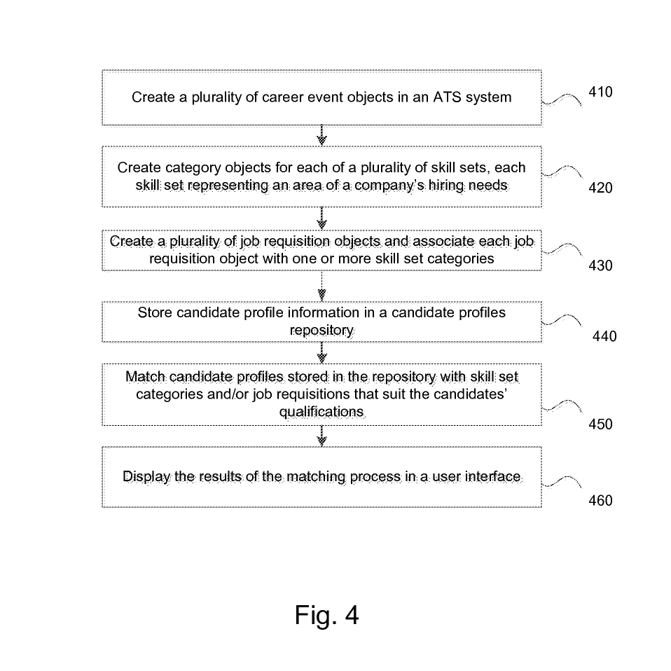

FIG. 4 is a flow diagram illustrating a method performed by an ATS engine according to one embodiment.

In 410, a plurality of career event objects are created in an ATS system. These career event objects may be created by a recruiter for example. A recruiter may access the ATS system to create and enter the details of one or more career events which the company plans to participate in or host. The event descriptions may include the event information described above relating to a name of an event, a location, date, and time.

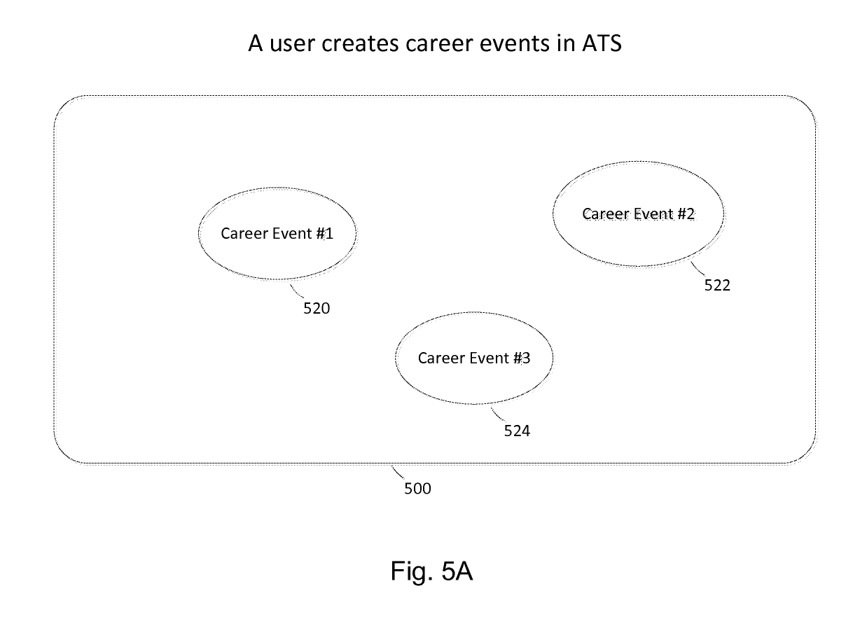

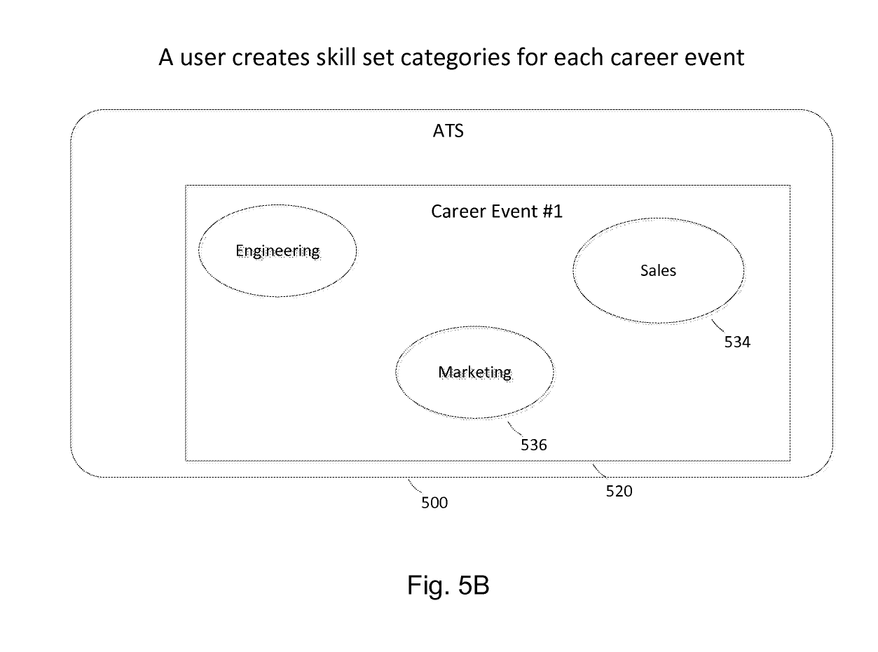

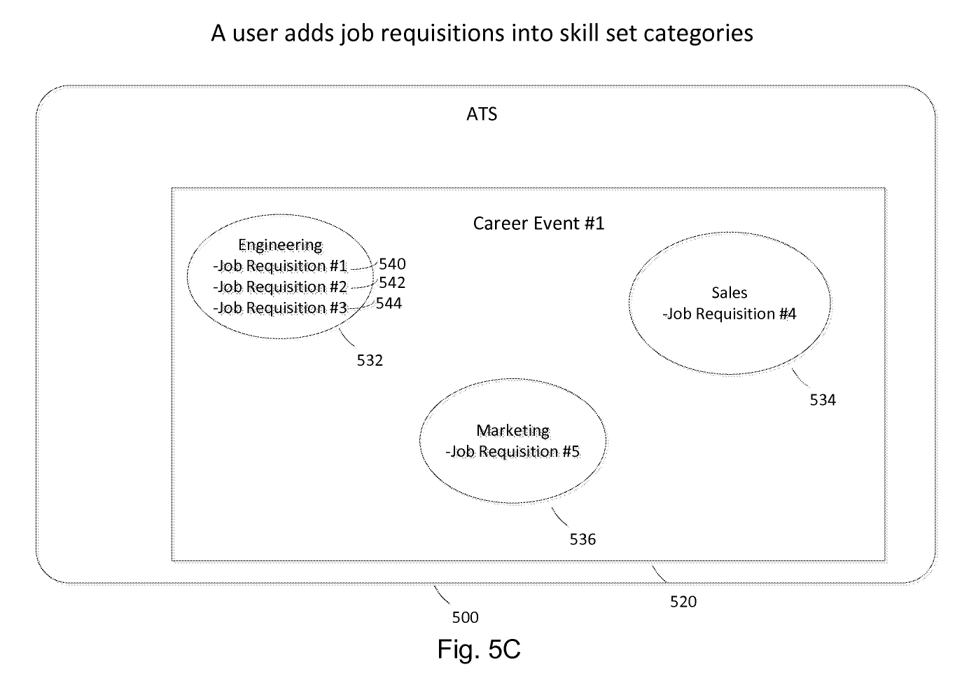

An illustration of this step is shown in FIG. 5A. An ATS is indicated by element 500. Elements 520, 522 and 524 show examples of career event objects.

In 420, objects for each of a plurality of categories of skills, or departments, in a company are created, and the objects are associated with one or more of the career event objects created in step 410.

FIG. 5B illustrates this step. It shows an event object 520 created for Career Event #1. It also shows three category objects—an object 532 for engineering, an object 534 for sales, and an object 536 for marketing—associated with event object 520. The category objects correspond to skill sets or departments within a company which are in need of new employees. These category objects are associated with Career Event #1 because it is desired to find potential candidates for the needs in these categories at Career Event #1.

In 430, job requisition objects are created; these objects each represent a specific open job position at the company, and they are associated with one of the job categories 532, 534 or 536.

FIG. 5C illustrates this step. It shows event object 520 representing Career Event #1. As noted above, the event object may be associated with event information identifying, for example, an event, a location, date, and time, where the recruiter encountered the candidate.

Event object 520 illustrated in FIG. 5 is associated with three category-objects 532, 534 and 536, each representing a hiring need at the company. The identified hiring needs are in the categories of, respectively, engineering, sales and marketing. For example, FIG. 5C also shows five job requisition objects. Three of these job requisitions, specifically, 540, 542 and 544, represent job requisitions associated with category object 532, that is, they identify open engineering positions. As these job requisitions are associated with category object 532, it can be assumed that each of these three job openings is in the engineering department (and/or associated with an engineering skill set). As one example, job requisition 540 may represent an opening for a job as a computer programmer.

Each job requisition may be created by a user of the ATS system using a screen displayed in a user interface that provides fields for a user to employ to enter information about a new job requisition. Such a screen for entering job position information may include fields such as job title, job description, required skills, and required minimum experience level. In some embodiments, in addition to allowing a recruiter to create and enter the details of job requisitions, the screen may also contain a category option which enables a user to classify a requisition as belonging to a specific skill set category. The skill set category may correspond to one of the categories represented by category objects 532, 534 and 536, for example. Classifying job requisitions into different skill set categories enables each job requisition to be associated with a skill set category.

Note that the job requisition information may be entered into a user interface of mobile device 110 or on a user interface associated with a Web application, for example. In one example, a recruiter may enter information about job requisitions on a user interfaces of a Web Applications associated with the Applicant Tracking System (ATS) itself.

In 440, candidate profiles are saved in candidate profiles repository 134. In some embodiments, this may occur while a recruiter is at a job fair or career event. As described above in connection with FIG. 2, while at a career event, a recruiter may use the intelligent recruiting tool to scan and upload candidate profile data to ATS engine 130 using mobile device 110.

The candidate profiles may be associated with information identifying an event at which the candidate came to the attention of a recruiter, or a date at which such an encounter occurred. For example, where candidates were interviewed or encountered at a career event, the career event may be identified in the candidate profile. Associating candidate profiles with event identifying information may, for example, allow a recruiter to perform focused searches, for example, for all candidates who were encountered at Career Event #1, for example. Such an event-based filtering process is discussed in more detail below.

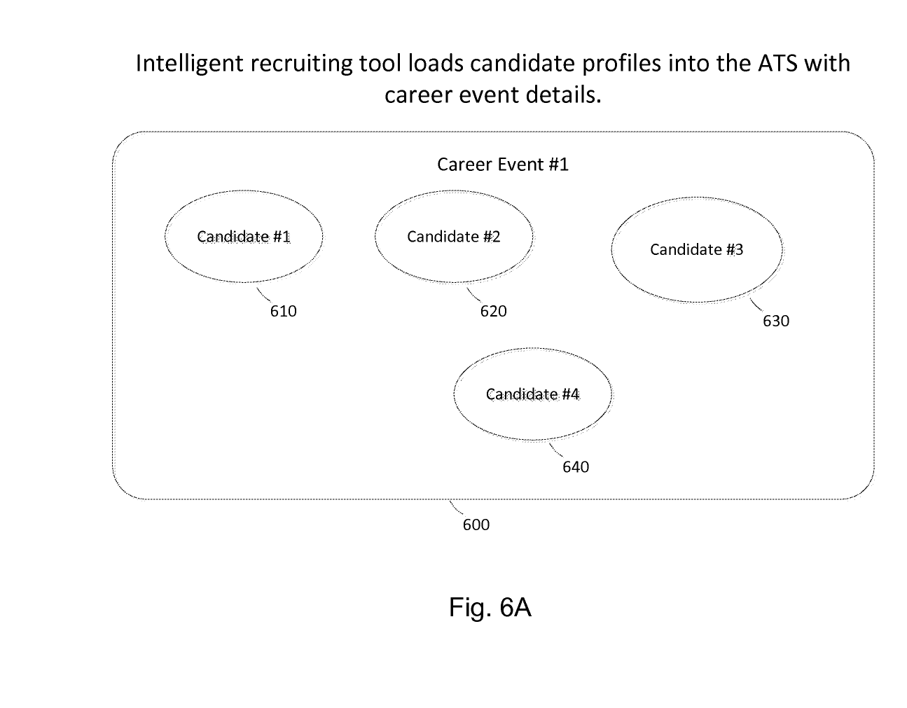

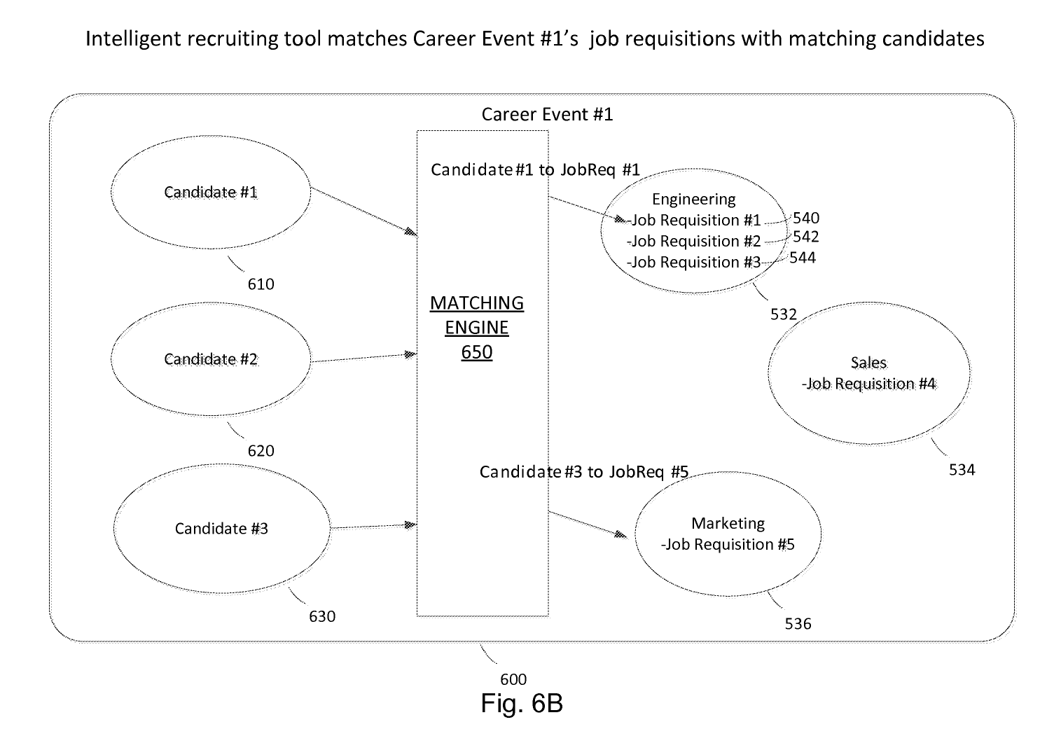

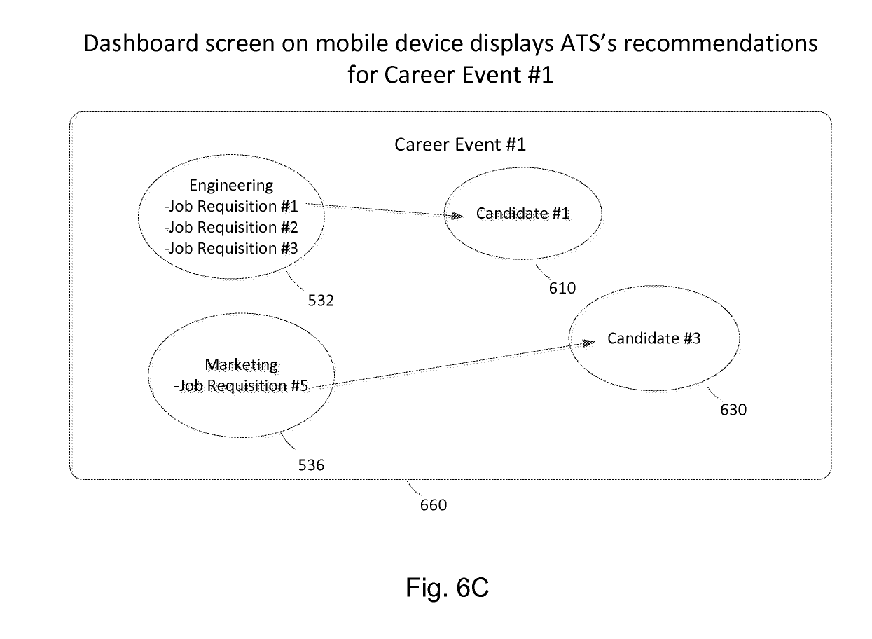

FIG. 6A provides a schematic diagram which illustrates candidate data retrieved from candidate profiles repository 134. Candidate objects 610, 620, 630, and 640 represent four candidates encountered at Career Event #1 600.

In 450, the system may match and classify the candidate profiles with appropriate skill set needs/categories. In the alternative, or in addition, matching engine 132 of ATS engine 130 may match and classify the candidate profiles with appropriate job requisitions. In one embodiment, this can involve two steps: a skill matching module 132 may first classify candidate profiles according to skill set categories. It may then match candidate profiles to particular job requisitions for which a candidate profile is a match. Being a match in this context refers to a candidate's skill set—for example, knowledge of certain programming languages—meeting the requirements for a particular job position. This process in effect achieves mapping of candidate data received at a career event, with appropriate skill set or job requisition categories.

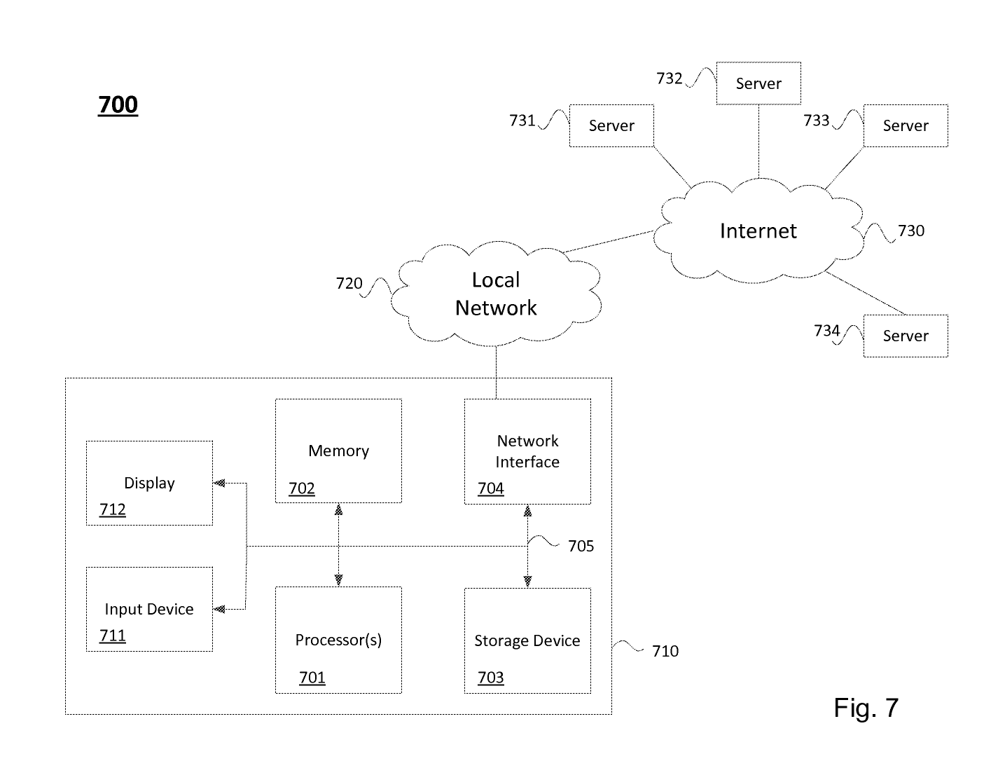

FIG. 6B illustrates this step. Matching engine 650 is provided with information about candidates and job requisitions pertaining to Career Event #1. As shown in FIG. 7B, matching engine 650 is given information about Candidate #1, Candidates #2 and Candidates #3 (610, 620 and 630 respectively). It also is provided with information about Job Requisition #1, Job Requisition #2, Job Requisition #3, Job Requisition #4, and Job Requisition #5. Candidate #1 is matched to Job Requisition #1. And Candidate #3 is matched to Job Requisition #3. The other candidate is not matched to any job requisitions.

In 470, the results of the matching performed by matching engine 650 of ATS engine 130 are displayed to a user (e.g., a recruiter). In some embodiments, the results may be displayed to a user through a computing device that is directly connected to ATS engine 130. In other embodiments, the results may be displayed to a user through mobile device 110; in this latter case, ATS engine 130 transmits results information to mobile device 110 for displaying to a user. Note that the system may display results either skill set category matches and/or job requisitions matches to a user. In some embodiments, the one or both of these matches may be displayed in what may be referred to as a “dashboard” of a user interface, that gives a user a variety of option for interacting with the ATS system. The user interface may be displayed as part of an application downloaded to mobile device 110, or in other embodiments, the user interface may be part of a Web application associated with the Applicant Tracking System (ATS) itself, for example.

As one example, in some embodiments, the screen on which matching results are displayed to a user may provide options for the user (e.g., a recruiter) to moderate and/or validate the ATS's recommendations concerning candidate to job requisition matches (or candidate to skill set category matches). Note that the matching results may be reviewed by different recruiters, not just the one who interviewed the candidate. Providing an initial procedure for automated processing of candidate data, the results of which can be shared by different recruiters, provides a more efficient way to utilize recruiters' areas of expertise and time. It allows the results of information obtained by one recruiter to be reviewed by another recruiter who may have more experience with a particular skill set area. The solution thereby effectively manages the availability of recruiters/specialists from different departments in the company by enabling a company to send candidate profiles in close to real time to the relevant skill specialists.

As noted above, in some embodiments, the system may provide a filtering option that permits recruiters to access candidate data on an event by event basis, thus permitting recruiters to more easily identify which new candidate were identified at a particular career event or job fair, for example. Such filtering may be performed at the matching stage, and/or at the display stage, depending on the embodiment. Further, such filtering may be performed using the above described event information associated with candidate data. As noted above, such event information may include information such as identifying information regarding an event, a location, day, and time, at which a recruiter encountered the candidate and received their resume, for example.

In addition to allowing retrieval of candidate data relating to a specific career event or job fair, where the event information includes date information (that is, the date of a candidate encounter), the system may also be able to filter candidate data so that a recruiter may focus their search to only receive information regarding newly encountered candidates (based on a time frame entered by the recruiter) if desired. Similar filtering may be performed based on location or other event information.

The ability to filter candidate data in such ways provides recruiters with the ability to focus on particular subgroups of candidates (for example, those candidates encountered recently, or those candidates, for example, encountered at a particular school) if useful for purposes of the recruiting process. Further, providing such filtering functionality provides the advantage of giving a company useful information regarding which career events, for example, produced the highest or lowest number of promising candidate leads, thus enabling the company to make better decisions regarding future allocations of recruiting resources.

FIG. 6C provides an illustration of the items that may be contained on a dashboard screen displayed on mobile device 110 that may be used to provide a user with the results of a matching process performed by ATS engine 130. As shown in FIG. 6C, in this example embodiment, Job Requisition #1 has been matched with Candidate #1, that is, Candidate #1 has been determined by the ATS engine 130 to be a potential candidate for Job Requisition #1. A match may be determined to exist, for example, based on the skills and experience requirements for that position and the qualifications described in the candidate's resume. Further, as shown in FIG. 6C, Candidate #3 has been determined to be a possible match for Job Requisition #5, a position in the marketing department (or marketing skill-set-category).

Benefits of the solution described in the flow diagram of FIG. 4 include eliminating the need for a recruiter to manually classify candidate resumes based on skill sets and/or job requisitions. Another advantage is that a recruiter is able to more easily manage and track the candidates encountered at a career event, and manage further processing of the candidate's information. Further, another advantage is that the matching system for matching candidates to job requisitions and skill needs assists in channeling the right candidates to the appropriate user (e.g., recruiters in a company) in an efficient manner.

FIG. 7 illustrates hardware of a special purpose computing machine configured with a process according to the above disclosure. The following hardware description is merely one example. It is to be understood that a variety of computers topologies may be used to implement the above described techniques. An example computer system 710 is illustrated in FIG. 7. Computer system 710 includes a bus 705 or other communication mechanism for communicating information, and one or more processor(s) 701 coupled with bus 705 for processing information. One or more processor(s) 701 may take various forms including microcontrollers and microprocessors such as programmable devices (e.g., CPLDs and FPGAs) and unprogrammable devices such as gate array ASICs or general purpose microprocessors. Computer system 710 also includes a memory 702 coupled to bus 705 for storing information and instructions to be executed by processor 701, including information and instructions for performing some of the techniques described above, for example. This memory may also be used for storing programs executed by processor 701. Memory 702 may comprise a single or multiple storage components or devices. Possible implementations of this memory may be, but are not limited to, random access memory (RAM), read only memory (ROM), or both. A storage device 703 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 703 may include source code, binary code, or software files for performing the techniques above, for example. Storage device and memory may both include any suitable non-transitory computer-readable media such as those described herein. Memory 702 and storage device 703 may comprise a single or multiple memory or storage components or devices, respectively.

Computer system 710 may be coupled via bus 705 to an output device 712 for providing information to a computer user. Output device 712 may take the form of a display or speakers, for example. An input device 711 such as a keyboard, touchscreen, mouse, and/or microphone, may be coupled to bus 705 for communicating information and command selections from the user to processor 701. The combination of these components allows the user to communicate with the system. In some systems, bus 705 may represent multiple specialized buses, for example.

Computer system 710 also includes a network interface 704 coupled with bus 705. Network interface 704 may provide two-way data communication between computer system 710 and a local network 720. The network interface 704 may be a wireless or wired connection, for example. Computer system 710 may send and receive information through the network interface 704 across a local area network, an Intranet, a cellular network, or the Internet, for example. One example implementation may include computing system 710 acting as an applicant tracking system (ATS) engine that receives a captured image of resumes from mobile devices, and processes those images to generate candidate profiles, among other things, as described above. In the Internet example, computing system 710 may be accessed by the mobile devices through a wireless connection to the Internet, for example, and computing system 710 may access data and features on backend systems that may reside on multiple different hardware servers 731-735 across the network. Servers 731-735 and server applications may also reside in a cloud computing environment, for example. Various embodiments may be practiced in a wide variety of network environments including, for example, TCP/IP-based networks, telecommunications networks, cellular communications networks, wireless networks, etc., or combinations of different network types.

As noted above, the apparatuses, methods, and techniques described below may be implemented as a computer program (software) executing on one or more computers. The computer program may further be stored on a tangible non-transitory computer readable medium, such as a memory or disk, for example. A computer readable medium may include instructions for performing the processes described herein. Examples of such computer readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM).

In addition, the computer program instructions with which various embodiments of this disclosure are implemented may be executed according to a variety of computing models including a client/server model, a peer-to-peer model, on a stand-alone computing device, or according to a distributed computing model in which various functions described herein may be performed at different locations.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed:

1. A method comprising:
receiving, at a computing device, a request identifying an event and one or more skill categories;
identifying, at the computing device, candidate profiles associated with the event and the one or more skill categories;
generating, at the computing device, a graphical dashboard including information identifying the event, the one or more skill categories and a total number of candidate profiles associated with the one or more skill categories; and
providing the graphical dashboard to a mobile device or Web application.

2. The method of claim 1 further comprising:
storing data about a company's hiring needs in a hiring needs data structure, wherein the company's hiring needs are divided into skill categories, each skill category associated with a particular group of skills or with a particular department of the company, and
wherein job requisitions for specific job openings at a company are associated with one or more of the skill categories.

3. The method of claim 1, wherein the hiring needs data structure is associated with a particular career event, and is used to hold information regarding hiring needs for which recruiters are seeking job candidates at said career event.

4. The method of claim 1, further comprising matching a first job requisition stored in the hiring needs data structure with a first candidate about whom candidate information is stored in a candidate information repository.

5. The method of claim 3, wherein the results of such matching are displayed to a user, and wherein the user is given the option of filtering the results of such matching to present only the job candidates matching the job requisitions who were encountered at a specific career event or during a specific time frame.

6. The method of claim 1 further comprising:
receiving image data relating to an image captured by a mobile device, the captured image depicting one or more text documents containing candidate data about a job candidate;
performing an image to text conversion process on the image data to generate a text file containing the contents of the captured text document(s);
parsing the text file generated by the image to text conversion process to generate a structured language file identifying characteristics of the job candidate, the characteristics including qualifications of the job candidate;
storing the structured language file identifying qualifications of the job candidate, or objects based on the structured language file, in a candidate information repository;
generating meta data relating to the job candidate; and
sending a message including the meta data to the mobile device.

7. The method of claim 6, further comprising:
identifying candidate profile information from the structured language file, wherein the identified candidate profile information includes at least one of contact information, work experience, academic background, professional skills, and interests; and
generating a candidate profile for the job candidate including the identified candidate profile information.

8. The method of claim 6, wherein the meta data comprises a notification that a candidate profile has been created for the job candidate on a company's career site, and information identifying a location of the company's career site, and identifying information needed to access the candidate profile on the career site.

9. The method of claim 6, further comprising:
sending a notification to the job applicant, the notification including one or more of an invitation to apply for a job position, a description of the job position, and a link to a job application system.

10. The method of claim 9, wherein the notification includes one or more of the following: information identifying a job fair event, contact information for a recruiter, and information identifying one or more professional skills of the job candidate that match one or more skill requirements for the job position.

11. The method of claim 6, further comprising performing a matching process to generate the meta data, wherein the matching process comprises comparing skill set requirements of a plurality of job requisitions with skill sets of a plurality of job candidates whose candidate information is stored in the candidate information repository and who were encountered at a specified career event.

12. The method of claim 1, wherein event information relating to an event at which the job candidate was encountered by a recruiter is identified, wherein the event information includes one or more of the following: name of an event, a location, date, and time.

13. The method of claim 12, wherein the candidate profile is associated with information identifying an event at which the job candidate encountered a recruiter, or a date at which the job candidate encountered a recruiter, and wherein associating the candidate profile with such information allows searches of the candidate information repository to be filtered such that only candidates encountered at a specified event or in a specified time frame are presented in response to a search request.

14. The method of claim 1, wherein the structured language file takes the form of one or more HR XML files, said HR XML files representing characteristics of the job candidate, including details relating to the job candidate's skills and/or experience.

15. The method of claim 1, wherein the objects based on the structured language file which are stored in the candidate information repository are Applicant Tracking System (ATS) domain objects.

16. The method of claim 1, further comprising:
receiving text data from the mobile device, the text data representing a recruiter's notes regarding an interaction between the recruiter and the job candidate, the text data obtained via a user interface of the mobile device or of a Web application; and
associating the text data with the job candidate.

17. A computer system comprising:
one or more processors; and
a non-transitory computer readable medium having stored thereon one or more programs, which when executed by the one or more processors, causes the one or more processor to singly or in combination:
receive a request identifying an event and one or more skill categories;
identify candidate profiles associated with the event and the one or more skill categories;
generate a graphical dashboard including information identifying the event, the one or more skill categories and a total number of candidate profiles associated with the one or more skill categories; and
provide the graphical dashboard to a mobile device or Web application.

18. The computer system of claim 17, wherein the one or more processors further:
store data about a company's hiring needs in a hiring needs data structure, wherein the company's hiring needs are divided into skill categories, each skill category associated with a particular group of skills or with a particular department of the company, and
wherein job requisitions for specific job openings at a company are associated with one or more of the skill categories.

19. The computer system of claim 17, wherein the one or more processors further:
send a notification to the job applicant, the notification including one or more of an invitation to apply for a job position, a description of the job position, and a link to a job application system.

20. A non-transitory computer readable storage medium storing one or more programs, the one or more programs comprising instructions for:
receiving image data relating to an image captured by a mobile device, the captured image depicting one or more text documents containing candidate data about a job candidate;
performing an image to text conversion process on the image data to generate a text file containing the contents of the captured text document(s);
parsing the text file generated by the image to text conversion process to generate a structured language file identifying characteristics of the job candidate, the characteristics including qualifications of the job candidate;
storing the structured language file identifying qualifications of the job candidate, or objects based on the structured language file, in a candidate information repository;
generating meta data relating to the job candidate; and
sending a message including the meta data to the mobile device.
